(19) United States
(12) Patent Application Publication
(10) Pub. No.: US 2026/0270553 A1
(43) Pub. Date: Sep. 10, 2026

(54) METHOD AND APPARATUS FOR RECOMMENDING CAMERA POSITION FOR PHOTOGRAPHING INTERIOR DESIGN

(71) Applicant: ARCHISKETCH INC., Seoul (KR)

(72) Inventors: Jusung LEE, Gwangmyeong-si, Gyeonggi-do (KR); Jong Seon HONG, Seoul (KR); Jun Ho KIM, Seoul (KR); Ji Su KIM, Seoul (KR)

(21) Appl. No.: 19/167,344

(22) PCT Filed: Sep. 14, 2023
(86) PCT No.: PCT/KR2023/013784

§ 371 Date: Sep. 19, 2025

(30) Foreign Application Priority Data
Jul. 3, 2023 (KR) 10-2023-0085476

(51) Int. Cl. H04N 23/60; G06V 10/762; G06V 10/82

(52) U.S. Cl. CPC H04N 23/64; G06V 10/762; G06V 10/82

(57) ABSTRACT

The present invention relates to a method for recommending a photographing position of a camera from which a high-quality rendered shot can be obtained when taking a photograph of the result of an interior design, and an apparatus for executing same. The present invention includes the steps of: obtaining interior drawing data; preprocessing the interior drawing data to generate object position data including information on three-dimensional positions of objects; inputting the object position data to a machine learning model or algorithm to generate camera position heatmap data including information on a camera position recommendation value for each coordinate; and generating camera position recommendation data including information on coordinates having recommendation values equal to or greater than a reference in the camera position heatmap data.

### TECHNICAL FIELD

The present invention relates to a method of recommending a photographing position of a camera that can acquire high-quality render shots when taking pictures of an interior design result, and an apparatus for executing the same.

More specifically, the present invention relates to a method and apparatus for recommending a photographing position of a camera using a machine learning model and an algorithm.

### BACKGROUND ART

The current scale of home remodeling market is estimated to be approximately 30 trillion Korean Won. As the demand for remodeling residential and commercial properties increases gradually, the interior design market has grown as much as approximately 7% every year and is expected to reach approximately 54 trillion Korean Won by the year 2026.

After the interior work is completed, the result of interior work may be photographed to report to the contractor or to make sales promotion. However, without professional photography expertise, it may be difficult to take appropriate pictures of the result of the interior work. Particularly, when photographing an interior design, it needs to appropriately select a camera position and angle to acquire render shots. However, selecting a photographing position and direction may be difficult for non-professional photographers. In addition, taking a plurality of render shots of a space where the interior work is completed, while considering the photographing position and direction each time, may be troublesome.

To this end, the market has launched an on-site photographing service of professional photographers, but coordinating the service schedule is troublesome and requires additional costs, and on-site photographing takes time.

### DISCLOSURE OF INVENTION

### Technical Problem

Therefore, the present invention has been made in view of the above problems, and it is an object of the present invention to provide a method of recommending a photographing position of a camera, which can acquire high-quality render shots when taking pictures of an interior design result, and an apparatus for executing the same.

### Technical Solution

To accomplish the above object, according to one aspect of the present invention, there is provided a method of recommending a camera position for photographing an interior design, the method comprising the steps of: generating object position data including three-dimensional position information of objects by preprocessing interior drawing data; generating camera position heatmap data including coordinate-specific camera position recommendation value information by inputting the object position data into a machine learning model or an algorithm; and generating camera position recommendation data including information on coordinates where the camera position recommendation value is equal to or greater than a reference recommendation value, from the camera position heatmap data.

As an embodiment, the object position data includes a floor plan displayed two-dimensionally, area information of the objects displayed on the floor plan, and height information of the objects.

As an embodiment, the step of generating object position data acquires area information of the objects by executing semantic segmentation or instance segmentation.

As an embodiment, the method further comprises, before the step of generating camera position heatmap data, a machine learning model training step of updating parameters of the machine learning model using a plurality of learning data having area information of the objects as an input variable and a camera position recommendation value at each coordinate point and angle as a target variable, in the machine learning model, which is a convolutional neural network.

As an embodiment, the algorithm includes the steps of: clustering one or more objects in the same space; searching for a center point of the cluster; and calculating the coordinate-specific camera position recommendation value information at each position of a camera photographing the center point of the cluster.

As an embodiment, the step of calculating the coordinate-specific camera position recommendation value information calculates the camera position recommendation value information at a camera position where there are no walls, pillars, doors, or objects on a straight line connecting the center point of the cluster and the camera.

As an embodiment, the method further comprises the step of performing rendering to display a point corresponding to coordinates where the camera position recommendation value is equal to or greater than the reference recommendation value on the object position data as a shape.

According to another aspect of the present invention, there is provided a computer program that is computer-readable instructions stored in a recording medium to execute the method of recommending a camera position for photographing an interior design.

An apparatus for recommending a camera position for photographing an interior design according to an embodiment of the present invention comprises: a preprocessing module for generating object position data including three-dimensional position information of objects from interior drawing data; a heatmap generation module for generating camera position heatmap data including coordinate-specific camera position recommendation value information by inputting the object position data into a machine learning model or an algorithm; and a position determination module for generating camera position recommendation data including information on coordinates, where the camera position recommendation value is equal to or greater than a reference recommendation value, from the camera position heatmap data.

As an embodiment, the preprocessing module acquires area information of the objects by executing semantic segmentation or instance segmentation.

As an embodiment, the apparatus further comprises a machine learning module for updating parameters of the machine learning model using a plurality of learning data having area information of the objects as an input variable and a camera position recommendation value at each coordinate point and angle as a target variable, in the machine learning model, which is a convolutional neural network.

As an embodiment, the heatmap generation module clusters one or more objects in the same space, searches for a center point of the cluster, and calculates the coordinate-specific camera position recommendation value information at each position of a camera photographing the center point of the cluster.

As an embodiment, the apparatus further comprises a rendering module for displaying a point corresponding to coordinates where the camera position recommendation value is equal to or greater than the reference recommendation value on the object position data as a shape.

### Advantageous Effects

According to an embodiment of the present invention, as information on the photographing position of a camera is provided in plurality using a pre-learned machine learning model or algorithm, a user may acquire a plurality of render shots of an interior work result without consuming much time and cost.

### BRIEF DESCRIPTION OF THE DRAWINGS

FIG. 1 is a block diagram schematically showing a camera position recommendation apparatus for photographing an interior design according to an embodiment of the present invention.

FIG. 2A and FIG. 2B are flowcharts each schematically illustrating a method of recommending a camera position for photographing an interior design according to an embodiment of the present invention.

FIG. 3 is a view showing interior drawing data in an embodiment of the present invention.

FIG. 4 is a view schematically showing segmentation of objects from interior drawing data in an embodiment of the present invention.

FIG. 5 is a view schematically showing the learning process of a machine learning model in an embodiment of the present invention.

FIG. 6A and FIG. 6B are views schematically showing the center point of an object cluster in an embodiment of the present invention.

FIG. 7 schematically shows a view of photographing the center point of an object cluster in an embodiment of the present invention.

FIG. 8 is a view schematically showing camera position rendering data indicating recommended points of photographing position and direction of a camera in an embodiment of the present invention.

### BEST MODE FOR CARRYING OUT THE INVENTION

Hereinafter, only the principles of the present invention will be exemplified. Therefore, although not clearly described or shown in this specification, those skilled in the art will be able to implement the principles of the present invention and invent various devices included in the spirit and scope of the present invention. In addition, it should be understood that all conditional terms and embodiments listed in this specification are, in principle, clearly intended only for the purpose of understanding the concept of present invention, and not limited to the embodiments and states specially listed as such.

In addition, it should be understood that all detailed descriptions listing specific embodiments, as well as the principles, aspects, and embodiments of the present invention, are intended to include structural and functional equivalents of such matters. In addition, it should be understood that such equivalents include equivalents that will be developed in the future, as well as currently known equivalents, i.e., all devices invented to perform the same function regardless of the structure.

Accordingly, for example, the block diagrams in the specification should be understood as expressing the conceptual viewpoints of exemplar circuits that embody the principles of the present invention. Similarly, all flowcharts, state transition diagrams, pseudo code, and the like may be practically embodied on computer-readable media, and it should be understood that regardless of whether or not a computer or a processor is explicitly shown, they represent various processes performed by the computer or processor.

The functions of various devices shown in the drawings, including functional blocks represented as a processor or a concept similar thereto, may be provided using hardware capable of executing software in connection with appropriate software, as well as dedicated hardware. When the functions are provided by a processor, the functions may be provided by a single dedicated processor, a single shared processor, or a plurality of individual processors, and some of the functions may be shared.

In addition, explicit use of the terms presented as a processor, control, or concepts similar thereto should not be interpreted by exclusively quoting hardware having an ability of executing software, and should be understood to implicitly include, without limitation, digital signal processor (DSP) hardware, and ROM, RAM and non-volatile memory for storing software. Other known common hardware may also be included.

In the claims of this specification, a component expressed as a means for performing a function described in the detailed description is intended to include any method that performs the function, including, for example, a combination of circuit elements performing the function, or any form of software including firmware, microcode, and the like, and is combined with appropriate circuits for executing the software to perform the function. since the present invention defined by these claims is combined with functions provided by various means listed therein and combined with the methods required by the claims, any means capable of providing the functions should be understood as being equivalent to that grasped from this specification.

The above objects, features, and advantages will become more apparent through the following detailed description related to the accompanying drawings, and accordingly, those skilled in the art may easily implement the technical spirit of the present invention. In addition, when it is determined in describing the present invention that the detailed description of a known technique related to the present invention may unnecessarily obscure the gist of the present invention, the detailed description will be omitted.

Hereinafter, embodiments of the present invention will be described in detail with reference to the drawings.

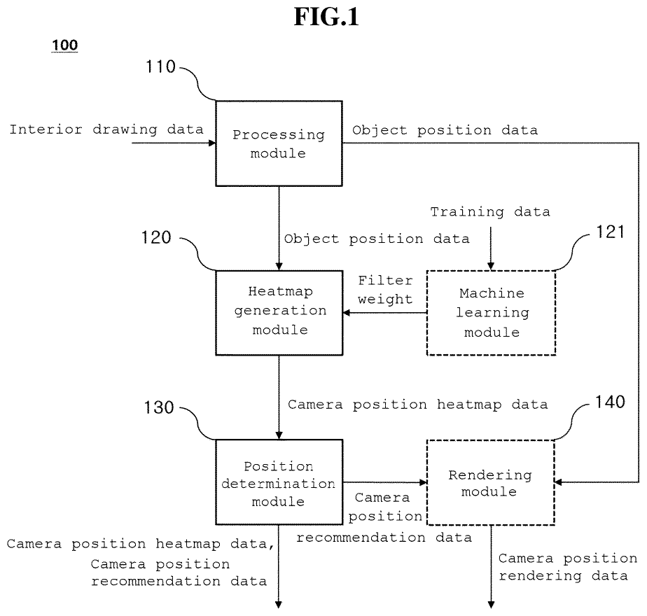

FIG. 1 is a block diagram schematically showing a camera position recommendation apparatus for photographing an interior design according to an embodiment of the present invention.

A camera position recommendation apparatus 100 for photographing an interior design according to an embodiment of the present invention includes a preprocessing module 110, a heatmap generation module 120, and a position determination module 130, and may further include a machine learning module 121, and a rendering module 140.

The preprocessing module 110 generates object position data including three-dimensional position information of objects from interior drawing data. In the present invention, an “object” refers to a thing such as furniture, home appliance, or lighting fixture that occupies an area in a space. The interior drawing data that the preprocessing module 110 receives may be a two-dimensional or three-dimensional CAD file or two-dimensional image data including a floor plan. For example, the interior drawing data may have a file format produced when the interior drawing is generated using a CAD program such as AutoCAD, CATIA, SolidWorks, 3ds Max, SketchUp, or the like.

The object position data may be in a format that records existence of an object at each orthogonal coordinate point in a three-dimensional space or in a format that includes information on the areas occupied by the object in a three-dimensional space. For example, when an object exists at the coordinate point, the object position data may be in a format that indicates the code of each object type (furniture, home appliances, lighting fixtures, etc.) at the coordinate point (x, y, z) with respect to the first to third axes orthogonal to each other. Alternatively, the object position data may be in a format that includes a floor plan displayed two-dimensionally, information on the areas occupied by the objects displayed on the floor plan, and height information of the objects.

The preprocessing module 110 may acquire information on the area of the objects by executing semantic segmentation or instance segmentation. For example, the preprocessing module 110 may execute semantic segmentation using U-Net or execute instance segmentation using a mask-R convolutional neural network (mask-R CNN).

The heatmap generation module 120 generates camera position heatmap data including coordinate-specific camera position recommendation value information by inputting the object position data into a machine learning model or an algorithm. The coordinate-specific camera position recommendation value information may indicate a score that can acquire a high-quality render shot when the camera is positioned at each orthogonal coordinate point on a three-dimensional or two-dimensional floor plan. For example, the heatmap generation module 120 may assign a score of 60 points at a three-dimensional coordinate point of (5, 10, 20) or 80 points at a two-dimensional coordinate point of (30, 50).

Alternatively, the coordinate-specific camera position recommendation value information may indicate a score that can acquire a high-quality render shot at each orthogonal coordinate point and each camera direction at the coordinate point on a three-dimensional or two-dimensional floor plan. For example, the heatmap generation module 120 may assign a score of 90 points when the angle of the camera rotates 20° around the first axis, 30° around the second axis, and 50° around the third axis at the coordinate point of (5, 10, 20) in a three-dimensional space.

When the heatmap generation module 120 utilizes a machine learning model, the machine learning model may be a convolutional neural network. The machine learning module 121 updates the parameters included in the machine learning model using a plurality of learning data, in which area information of the objects is an input variable, and coordinate-and angle-specific camera position recommendation values are a target variable. The parameters may be weights belonging to a plurality of filters of the convolutional neural network. Before the heatmap generation module 120 generates camera position heatmap data using the machine learning model, the machine learning module 121 trains the machine learning model and updates the weights belonging to a plurality of filters of the convolutional neural network.

When the heatmap generation module 120 utilizes an algorithm, the algorithm clusters one or more objects in the same space, searches for the center point of the cluster, and calculates coordinate-specific camera position recommendation value information at each position of the camera photographing the center point of the cluster. The algorithm may calculate camera position recommendation value information at a camera position where there are no walls, pillars, doors, or objects on the straight line connecting the center point of the cluster and the camera.

The position determination module 130 generates camera position recommendation data including information on coordinates, where the camera position recommendation value is equal to or greater than a reference recommendation value, from the camera position heatmap data. The reference recommendation value may be a value set by the user. Alternatively, the position determination module 130 generates camera position recommendation data including coordinate information, where the camera position recommendation value is within the top R, in each space. For example, the position determination module 130 may search for coordinates where the camera position recommendation value is within the top three in the living room, and include information on the searched coordinates in the camera position recommendation data. The position determination module 130 may output the camera position heatmap data and the camera position recommendation data to the outside of the system 100.

The rendering module 140 displays a point corresponding to coordinates where the camera position recommendation value is equal to or greater than the reference recommendation value on the object position data as a shape. The rendering module 140 displays a point corresponding to coordinates where the camera position recommendation value is equal to or greater than the reference recommendation value or a point corresponding to coordinates where the camera position recommendation value is within the top R on the object position data as a shape, processes the points as camera position rendering data, and outputs the camera position rendering data to the outside of the system 100. In addition, the photographing direction may be displayed together with the points on the object position data. A terminal or a computer having a display device displays the camera position rendering data so that the user may confirm.

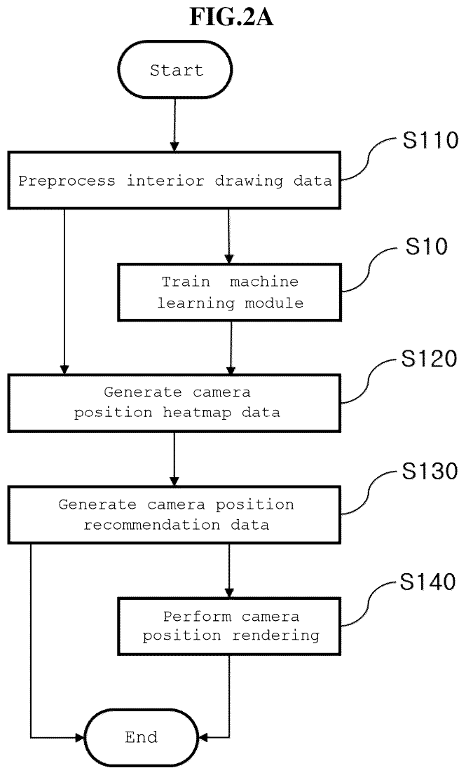

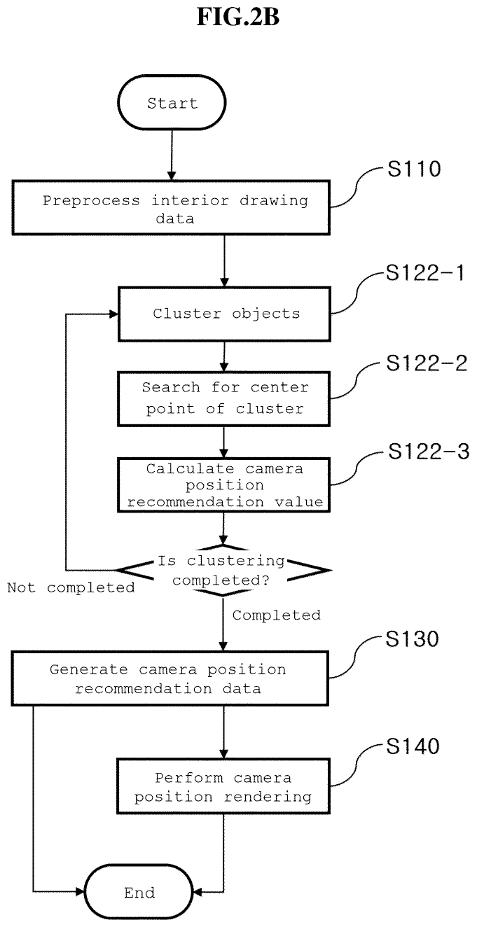

Hereinafter, a method of recommending a camera position for photographing an interior design according to an embodiment of the present invention will be described in detail with reference to FIGS. 2A to 8 below.

The preprocessing module 110 generates object position data including three-dimensional position information of objects by preprocessing interior drawing data. (Step S110)

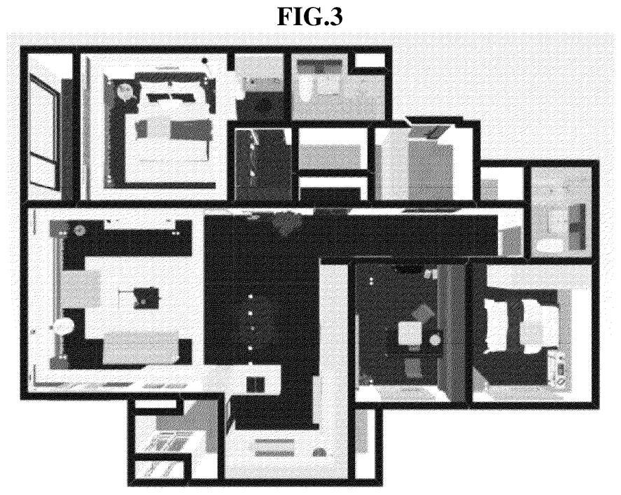

The interior drawing data that the preprocessing module 110 receives as an input may be a two-dimensional or three-dimensional CAD file or two-dimensional image data including a floor plan. For example, the preprocessing module 110 may receive a three-dimensional CAD file of a building as shown in FIG. 3 from the outside of the system 100, convert the CAD file into a floor plan, i.e., a top view shown two-dimensionally, and generate object position data including information on the areas occupied by the objects displayed on the floor plan and information on the height of the objects.

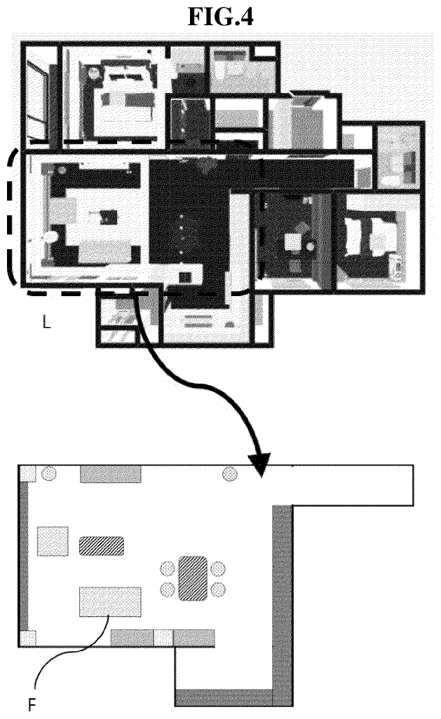

The preprocessing module 110 may acquire information on the area of the objects by executing semantic segmentation or instance segmentation. For example, as shown in FIG. 4, the preprocessing module 110 may segment objects such as the furniture F in the living room space L by executing instance segmentation using a mask-R convolutional neural network (mask-R CNN). In addition, the preprocessing module 110 may acquire information on the positions where a plurality of segmented objects is placed and the areas occupied by the objects, and generate object position data including the information.

The heatmap generation module 120 generates camera position heatmap data including coordinate-specific camera position recommendation value information by inputting the object position data into a machine learning model or an algorithm. (Step S120)

When the heatmap generation module 120 utilizes a machine learning model, the machine learning model may be a convolutional neural network. As shown in FIG. 2A, the machine learning module 121 may execute a pre-training step (step S10) before the step of generating the camera position heatmap data (S120). Alternatively, the pre-training step (S10) may be executed before the step of generating the object position data (S110). In addition, when training of the machine learning model is completed, the object position data may be input into the machine learning model without executing the pre-training step (S10) to generate coordinate-specific camera position recommendation value information.

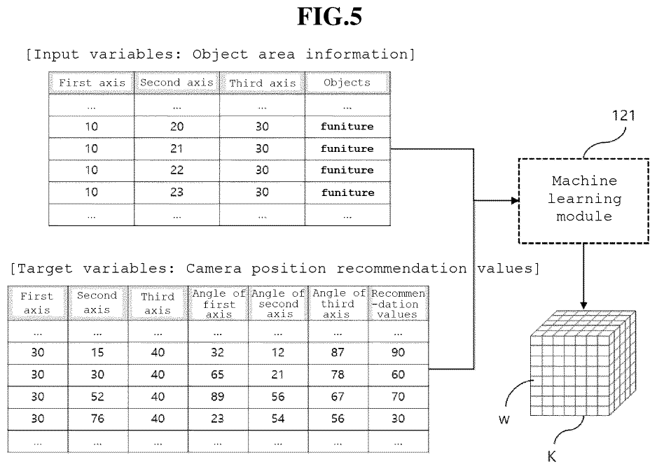

The machine learning module 121 may perform the pre-training by updating the parameters of the machine learning model using a plurality of learning data having area information of the objects as an input variable and a camera position recommendation value at each coordinate point and angle as a target variable. For example, as shown in FIG. 5, the input variable may be information on the coordinates occupied by the objects in the coordinate system of first to third axes orthogonal to each other. In addition, the target variables may be coordinates of a point and a camera position recommendation value at an angle rotated with respect to each of the first to third axes at the coordinate point.

When the machine learning model is a convolutional neural network, there may be a plurality of convolutional layers, and the filters K may have a three-dimensional shape. In addition, the machine learning module 121 may update the weights w of the filters K while progressing the learning.

When the heatmap generation module 120 utilizes an algorithm, the algorithm clusters objects to find a center point, and calculates a recommendation value at the position of each camera photographing the center point. For example, as shown in FIG. 2B, the algorithm may repeatedly execute, in each space, the steps of clustering one or more objects in the same space by the heatmap generation module 120 (step S122-1), searching for the center point of the cluster (step S122-2), and calculating coordinate-specific camera position recommendation value information at each position of the camera photographing the center point of the cluster (step S122-3).

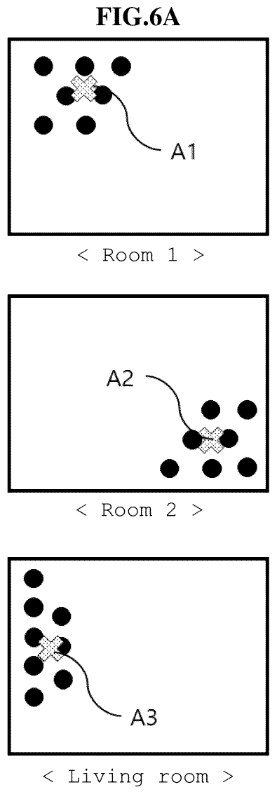

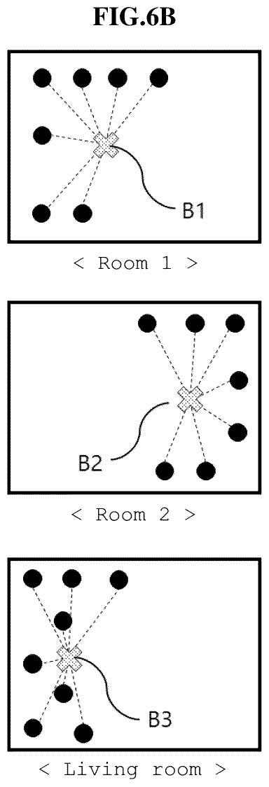

The heatmap generation module 120 obtains a coordinate-specific probability density by inputting position information of the objects in a space into the Kernel Density Estimation (KDE) function, and selects coordinates with the highest probability density as the center point of the cluster. For example, as shown in FIG. 6A, point A1 in Room 1, point A2 in Room 2, and point A3 in the living room, each having the highest coordinate-specific probability density, may be selected as the center point of the cluster, respectively.

The heatmap generation module 120 specifies a first search area in the object position data on the basis of an arbitrary point, and specifies a second search area centered on the point where the coordinate-specific probability density is the highest in the first search area. Then, the heatmap generation module 120 specifies a third search area centered on the point where the coordinate-specific probability density is the highest in the second search area. This process is repeated until the points where the probability density is the highest converge to a point, and then the converged point may be selected as the center point of the cluster. At this point, the first search area and the second search area may be in the shape of a circle or a sphere.

Alternatively, the heatmap generation module 120 calculates a sum of distances to a plurality of objects at each coordinate in a space, and then selects coordinates of the smallest sum of distances as the center point of the cluster. For example, as shown in FIG. 6B, point B1 in Room 1, point B2 in Room 2, and point B3 in the living room, each having the smallest sum of distances, may be selected as the center point of the cluster.

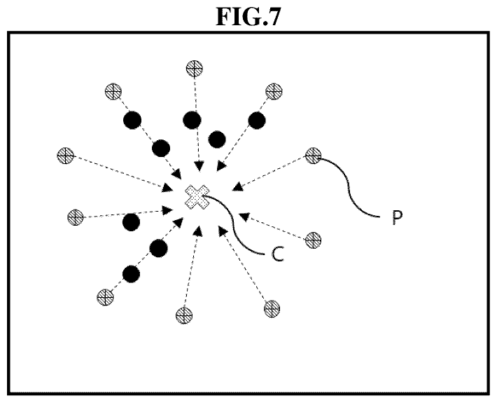

The heatmap generation module 120 calculates coordinate-specific camera position recommendation value information at the position of photographing the center point of the cluster. For example, as shown in FIG. 7, it may calculate camera position recommendation value information at each position P of photographing point C, which is the center point of a cluster, in a space. The camera position recommendation value may be obtained by reflecting the distance between the center point C and the camera position P, the direction from the camera position P toward the center point C, and information on the areas of the objects existing between the center point C and the camera position P.

Alternatively, the heatmap generation module 120 may calculate camera position recommendation value information only at a camera position where there are no walls, pillars, doors, or other objects on the straight line connecting the center point of the cluster and the camera. For example, the camera position recommendation value information may be calculated only at the positions where there are no walls, pillars, doors, or other objects that may obstruct the view on the straight line connecting point C, i.e., the center point of the cluster, and point P where a camera can be placed.

The position determination module 130 generates camera position recommendation data including information on the coordinates where the camera position recommendation value is equal to or greater than a reference recommendation value, from the camera position heatmap data. (Step S130)

The position determination module 130 receives a reference recommendation value set by the user. Alternatively, the position determination module 130 generates camera position recommendation data in each space by including information on the coordinates where the coordinate-specific camera position recommendation value is within the top R. For example, the camera position recommendation data may include information on three coordinates where the coordinate-specific camera position recommendation values in the living room are within the top three.

Optionally, the rendering module 140 may perform rendering so that the points and photographing directions corresponding to the coordinates where the camera position recommendation value is equal to or greater than the reference recommendation value may be displayed as a shape on the object position data. (Step S140)

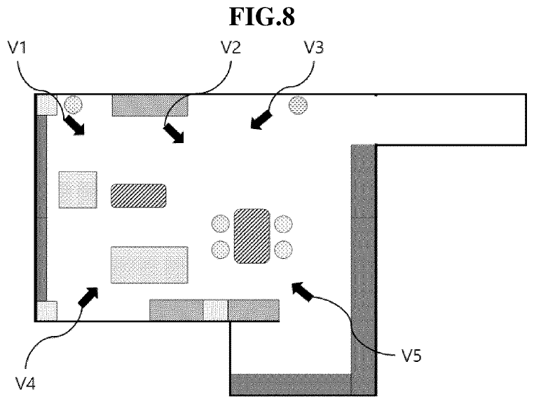

For example, as shown in FIG. 8, the rendering module 140 displays the points V1 to V5 corresponding to the coordinates where the camera position recommendation value obtained by the position determination module 130 is equal to or greater than the reference recommendation value as a shape on the object position data. At this point, the photographing direction may be displayed together as an arrow or the like.

When the heatmap generation module 120 utilizes a machine learning model, the photographing direction may be determined with reference to information on the angle rotated with respect to the first to third axes, together with the three-dimensional coordinate point included in the coordinate-specific camera position recommendation value information. Alternatively, when the heatmap generation module 120 utilizes an algorithm, the photographing direction may be determined as the direction facing the center point from the camera position.

In addition, the rendering module 140 processes the object position data as the shape displayed thereon into camera position rendering data, and outputs the camera position rendering data to the outside of the system 100.

The method of recommending a camera position for photographing an interior design according to an embodiment of the present invention described above may be stored in a recording medium as computer-readable instructions and executed as a computer program stored in the recording medium. The computer-readable recording medium may be, for example, a ROM, a RAM, a CD-ROM, a magnetic tape, a floppy disk, an optical data storage device, and the like.

Although the embodiments of the present invention have been described above, the present invention is not limited to the embodiments described above, and may be implemented by making various changes within the scope of the detailed description and attached drawings of the invention without departing from the spirit of the present invention as long as the effects are not impaired. Furthermore, it is obvious that such embodiments fall within the scope of the present invention.

1. A method of recommending a camera position for photographing an interior design, the method comprising the steps of:
generating object position data including three-dimensional position information of objects by preprocessing interior drawing data;
generating camera position heatmap data including coordinate-specific camera position recommendation value information by inputting the object position data into a machine learning model or an algorithm; and
generating camera position recommendation data including information on coordinates where the camera position recommendation value is equal to or greater than a reference recommendation value, from the camera position heatmap data.

2. The method according to claim 1, wherein the object position data includes a floor plan displayed two-dimensionally, area information of the objects displayed on the floor plan, and height information of the objects.

3. The method according to claim 1, wherein the step of generating object position data acquires area information of the objects by executing semantic segmentation or instance segmentation.

4. The method according to claim 1, further comprising, before the step of generating camera position heatmap data, a machine learning model training step of updating parameters of the machine learning model using a plurality of learning data having area information of the objects as an input variable and a camera position recommendation value at each coordinate point and angle as a target variable, in the machine learning model, which is a convolutional neural network.

5. The method according to claim 1, wherein the algorithm includes the steps of:
clustering one or more objects in the same space;
searching for a center point of the cluster; and
calculating the coordinate-specific camera position recommendation value information at each position of a camera photographing the center point of the cluster.

6. The method according to claim 5, wherein the step of calculating the coordinate-specific camera position recommendation value information calculates the camera position recommendation value information at a camera position where there are no walls, pillars, doors, or objects on a straight line connecting the center point of the cluster and the camera.

7. The method according to claim 1, further comprising the step of performing rendering to display a point corresponding to coordinates where the camera position recommendation value is equal to or greater than the reference recommendation value on the object position data as a shape.

8. A computer program that is computer-readable instructions stored in a recording medium to execute the method of recommending a camera position for photographing an interior design according to claim 1.

9. An apparatus for recommending a camera position for photographing an interior design, the apparatus comprising:
a preprocessing module for generating object position data including three-dimensional position information of objects from interior drawing data;
a heatmap generation module for generating camera position heatmap data including coordinate-specific camera position recommendation value information by inputting the object position data into a machine learning model or an algorithm; and
a position determination module for generating camera position recommendation data including information on coordinates, where the camera position recommendation value is equal to or greater than a reference recommendation value, from the camera position heatmap data.

10. The apparatus according to claim 9, wherein the preprocessing module acquires area information of the objects by executing semantic segmentation or instance segmentation.

11. The apparatus according to claim 9, further comprising a machine learning module for updating parameters of the machine learning model using a plurality of learning data having area information of the objects as an input variable and a camera position recommendation value at each coordinate point and angle as a target variable, in the machine learning model, which is a convolutional neural network.

12. The apparatus according to claim 9, wherein the heatmap generation module
clusters one or more objects in the same space,
searches for a center point of the cluster, and
calculates the coordinate-specific camera position recommendation value information at each position of a camera photographing the center point of the cluster.

13. The apparatus according to claim 9, further comprising a rendering module for displaying a point corresponding to coordinates where the camera position recommendation value is equal to or greater than the reference recommendation value on the object position data as a shape.
